(19) United States
(12) Patent Application Publication
(10) Pub. No.: US 2021/0183635 A1
(43) Pub. Date: Jun. 17, 2021

(54) METHOD FOR PRODUCING GASEOUS AMMONIUM FOR ION-MOLECULE-REACTION MASS SPECTROMETRY

(71) Applicant: IONICON ANALYTIK GESELLSCHAFT M.B.H., Innsbruck (AT)

(72) Inventor: Eugen HARTUNGEN, Innsbruck (AT)

(21) Appl. No.: 16/761,673

(22) PCT Filed: Dec. 20, 2018
(86) PCT No.: PCT/EP2018/086332

§ 371 Date: May 5, 2020

(30) Foreign Application Priority Data
Dec. 20, 2017 (EP) 17209017.7

(51) Int. Cl. H01J 49/14; H01J 49/04

(52) U.S. Cl. CPC H01J 49/145; H01J 49/0422

(57) ABSTRACT

Method for obtaining gaseous ammonium (NH₄⁺) from an ion source, the ion source comprising a first area (1) and a second area (2) in a fluidly conductive connection, comprising the steps of a) introducing N₂ and H₂O into the first area (1) and second area (2) of the ion source; b) applying an ionization method to the mixture of N₂ and H₂O in the first area (1); c) applying at least one electric field or adjusting pressure conditions or a combination of applying at least one electric field and adjusting pressure conditions promoting flow of ions from the first area (1) to the second area (2) and inducing reactions of the ions in the second area (2); d) conducting NH₄⁺ out of the ion source. Ion Molecule Reaction-Mass Spectrometry instrument implementing this method for producing NH₄⁺ and then conducting NH₄⁺ to the reaction region.

The present invention relates to a method for obtaining gaseous ammonium (NH₄⁺) from an ion source. The invention also relates to a method for ionizing a sample with gaseous ammonium, comprising obtaining ammonium and ionizing the sample in a reaction chamber. Furthermore, the invention relates to a method of detecting the ion yield of the mass-to-charge ratio of ions by detecting the ions in an MS-instrument. Finally, the invention relates to an IMR-MS instrument, comprising an ion source; a reaction region connected to said ion source; a mass spectrometer region connected to said reaction region; at least one inlet for source gases; at least one inlet for a sample into the reaction region; an N₂-source; a H₂O source; and at least one pump.

### BACKGROUND OF THE INVENTION

Gas analysis with Ion-Molecule-Reaction-Mass Spectrometry (IMR-MS) has been well established for many decades (see e.g. A. M. Ellis, C. A. Mayhew. Proton Transfer Reaction Mass Spectrometry Principles and Applications. John Wiley & Sons Ltd., UK, 2014). Among the most important techniques in this field are Proton-Transfer-Reaction-Mass Spectrometry (PTR-MS), Selected-Ion-Flow-Tube-Mass Spectrometry (SIFT-MS) and Selected-Ion-Flow-Drift-Tube-Mass Spectrometry (SIFDT-MS). In an ion source so-called primary or reagent ions are generated and injected into a reaction chamber (often called “drift tube” in PTR-MS, “flow tube” in SIFT-MS and “flow-drift tube” in SIFDT-MS), where chemical ionization of the analytes takes place. Typical chemical ionization reactions are:

Proton transfer reactions, either non-dissociative or dissociative, with A being the reagent ion (e.g. H₂O.H⁺, NH₃.H⁺, etc.) and BC being the analyte:

A.H⁺+BC→A+BC.H⁺

A.H⁺+BC→A+B+C.H⁺

Charge transfer reactions, either non-dissociative or dissociative, with A being the reagent ion (e.g. O₂⁺, NO⁺, Kr⁺, etc.) and BC being the analyte:

A⁺+BC→A+BC⁺

A⁺+BC→A+B+C⁺

Clustering reactions, with A being the reagent ion (e.g. H₃O⁺, NO⁺, O₂⁺, NH₄⁺) and BC being the analyte:

A⁺+BC→BC.A⁺

In addition other types of reactions can occur (e.g. ligand switching, H⁺ extraction in case of negatively charged reagent ions, etc.).

Eventually the reagent and product ions are separated by their mass-to-charge ratio m/z and detected in a mass spectrometer, amongst others, based on multipole, Time-Of-Flight (TOF) and ion trap technology. In addition, a series of common devices for controlling the various voltages, currents, temperatures, pressures, etc. need to be present in the instrument.

In PTR-MS traditionally H₃O⁺ is used as reagent ions. However, recent PTR-MS instruments are additionally capable of utilizing alternative reagent ions, e.g. NO⁺, O₂⁺, Kr⁺, NH₄⁺ and any other positively or negatively charged reagent ions and thus are sometimes called Selective-Reagent-Ionization-Mass Spectrometry (SRI-MS) instruments. Also in SIFT-MS and SIFDT-MS a variety of reagent ions can be used, with H₃O⁺, NO⁺ and O₂⁺ being the most common ones.

All of these reagent ions used in IMR-MS have distinct advantages, which make them particularly suitable for certain applications. A particular beneficial reagent ion is the ammonium cation NH₄⁺. NH₃ has a Proton Affinity (PA) of 854 kJ/mol, whereas H₂O has a PA of 691 kJ/mol. Proton transfer is energetically only possible if the PA of the analyte is higher than the PA of the reagent ion. Thus, some of the advantages of using NH₄⁺ are:

Improved selectivity: In IMR-MS often two or more compounds are detected at the same nominal m/z (e.g. isobars or isomers). If they share the same exact m/z (isomers) or if the mass resolution of the mass spectrometer is insufficient to separate isobars, additional measures have to be taken to distinguish them. Pinene (C₁₀H₁₆; PA<854 kJ/mol and >691 kJ/mol) and 2-ethyl-3,5-dimethylpyrazine (C₈H₁₂N₂; PA>854 kJ/mol) are mentioned as examples in the prior art. The protonated molecules of both compounds share nominal m/z 137 when using H₃O⁺ as reagent ions. However, with NH₄⁺ as reagent ions, only 2-ethyl-3,5-dimethylpyrazine gets protonated whereas pinene does not react. That is, if only one of these two compounds is present in a sample and ions are detected at m/z 137 with NH₄⁺ as reagent ions, the compound can be identified as 2-ethyl-3,5-dimethylpyrazine. If ions are detected at m/z 137 with H₃O⁺ as reagent ions, but not with NH₄⁺, the compound can be identified as pinene.

Simplification of mass spectra: If, for example, in a complex sample only compounds with a PA higher than the PA of NH₃ need to be detected and quantified, using NH₄⁺ reagent ions will blank out all analytes with a PA lower than the PA of NH₃ and thus will lead to a mass spectrum which is considerably easier to interpret than a mass spectrum generated with H₃O⁺ reagent ions.

Less fragmentation: Compounds with high PAs (>854 kJ/mol) often show high levels of fragmentation upon PTR ionization from H₃O⁺, which makes identification and quantification difficult. The explosive TATP (C₉H₁₈O₆) does not form the characteristic ion TATP.H⁺ (or only with a very low abundance), but many fragment ions when reacting with H₃O⁺ at a reduced electric field strength (E/N) which is typically used in PTR-MS. When switching to NH₄⁺ as reagent ions the protonated TATP molecule as well as TATP.NH₄⁺ are formed with high abundance and thus detection and identification of this explosive is improved. Another example is the Chemical Warfare Agent (CWA) sarin (C₄H₁₀FO₂P), which also shows a high level of fragmentation upon H₃O⁺ ionization. Using NH₄⁺ as reagent ions effectively suppresses fragmentation and produces the protonated sarin molecule as well as [sarin+NH₃].H⁺ clusters.

GB 2 324 406 B describes a method of generating NH₄⁺ reagent ions with high purity, so that they can be used without further filtering in a PTR-MS device. In this method NH₃ is introduced into the first ionization chamber of the ion source. The ionization products are subsequently left in the second ionization chamber of the ion source, together with NH₃, until the ionization products which are initially other than NH₄⁺ are converted into NH₄⁺ ions. This is a method similar to the method described in DE 195 49 144, which is used to generate H₃O⁺ from H₂O vapor, but with the source gas being NH₃ instead of H₂O.

In SIFT-MS NH₄⁺ reagent ions are generated in a similar way, namely by ionization of NH₃ in the ion source and subsequent ion-molecule reactions between NH₃⁺ and NH₃, which form NH₄⁺ (and NH₂).

In AT 413 463 B an extended ion source for PTR-MS is used, which is equipped with an additional ionization chamber. In order to generate NH₄⁺ the ion source is operated in a way such that in the second ionization chamber H₃⁺ is produced and introduced together with NH₃ into a third ionization chamber, where H₃⁺ and NH₃ react to NH₄⁺ (and H₂).

A different method of generating NH₄⁺ reagent ions in a PTR-MS instrument is described in DE 10 2011 009 503 A1. There, the PTR-MS instrument is operated so that the ion source produces H₃O⁺ reagent ions from H₂O source gas, i.e. in the most common way a PTR-MS instrument is being operated. However, NH₃ is introduced into the drift tube via the sample inlet at a sufficiently high concentration, so that the majority of the H₃O⁺ reacts with NH₃ to NH₄⁺ (and H₂O). In other words, H₃O⁺ reagent ions are converted to NH₄⁺ reagent ions in the drift tube by the introduction of NH₃.

In summary, all methods for generating NH₄⁺ in an IMR-MS instrument require the introduction of NH₃ into at least one part on the instrument. However, there are a number of considerable disadvantages when using NH₃ in an IMR-MS instrument:
NH₃ is toxic, corrosive and environmentally hazardous.
The use of NH₃ gas cylinders requires a high level of safety precautions and is prohibited in some areas.
The use of ammonia solutions as an NH₃ source does not provide a stable NH₃ concentration over time.
NH₃ can damage important parts of the instrument, such as lines, lenses, vacuum pumps, valves, flow controllers, etc.
The exhaust of the IMR-MS instrument is contaminated with NH₃ and needs to be properly disposed.
The surfaces inside the IMR-MS instrument get covered with NH₃ which desorbs very slowly after switching to a different reagent ion, i.e. switching from NH₄⁺ to H₃O⁺ takes tens of minutes if not hours.

### SHORT DESCRIPTION OF THE INVENTION

Due to the large number of disadvantages associated with the generation of NH₄⁺, this ion is rarely used in IMR-MS devices as reagent ion. H₃O⁺ is still the standard reagent ion despite its disadvantages such as lower selectivity, more complex mass spectra and higher levels of fragmentation.

The object of the present invention is to provide an ion source with higher selectivity, simpler spectra and less fragmentation when compared to H₃O⁺ but with less disadvantages than the known methods involving NH₃ in the generation of NH₄⁺.

The problem is solved by a method for obtaining gaseous ammonium (NH₄⁺) from an ion source, the ion source comprising a first area and a second area in a fluidly conductive connection, comprising the steps
(a) introducing N₂ and H₂O into the first and second area of the ion source;
(b) applying an ionization method to the mixture of N₂ and H₂O in the first area;
(c) applying at least one electric field or adjusting pressure conditions or a combination of applying at least one electric field and adjusting pressure conditions promoting flow of ions from the first area to the second area and inducing reactions of the ions in the second area,
(d) conducting NH₄⁺ out of the ion source.

Surprisingly it has been found that by applying an ionization method to a mixture of N₂ and H₂O in the first area of the ion source and then applying at least one field or adjusting pressure conditions or a combination of applying at least one field and adjusting pressure conditions thereby promoting flow of ions from the first area to the second and thereby also inducing collisions and thus reactions of the ions and neutral H₂O and N₂ in the second area, resulted a high yield of NH₄⁺ with almost no other ions, in particular no parasitic ions, in the second area. Absolutely no NH₃ needs to be added to this process at any stage, which is in stark contrast to the prior art, and therefore the negative side effects caused by the use of this dangerous, toxic and corrosive source gas in previous designs are diminished.

The at least one field is an electric field. The pressure and/or the electric field are such as to promote flow of ions resulting from the ionization process in the first area to the second area. Neutral N₂ and H₂O are introduced into the second area either by a flow of remaining neutrals from the first area or by injection into the second area (depending on the type and design of the ionization in the first area). Furthermore, the field and/or pressure are such to induce collisions in the second area and thus to promote NH₄⁺ formation. Furthermore, a magnetic field may be applied.

In one embodiment, step (c) includes maintaining the pressure in the second ionization chamber at a pressure below the pressure of the first ionization chamber and applying an electric field in the second ionization chamber to support flow of ions and remaining neutrals from the first ionization chamber to the second ionisation chamber, leading to NH₄⁺ formation via ion-molecule reactions in the second ionization chamber.

In one embodiment there is at least one source gas inlet for introducing N₂ and H₂O into the first area.

It turned out that the molar mixing ratio of N₂ and H₂O may be varied over a broad range to allow formation of NH₄⁺. Useful molar mixing ratios of N₂ to H₂O in the first ionization chamber are between 1:9 and 9:1. In a preferred embodiment the molar mixing ratios are between 3:7 and 7:3. Most preferably, the molar ratio between N₂ and H₂O is approximately 1:1.

Though, the N₂ source may be any gaseous source of N₂ such as air, in a preferred embodiment the N₂ source is essentially pure gaseous N₂.

In one embodiment N₂ and H₂O are mixed before the introduction into the first ionization chamber.

Alternatively, N₂ and H₂O are introduced into the first area separately and are mixed directly in first area.

In one embodiment N₂ and/or H₂O are introduced in the second area and N₂ and/or H₂O flow to the first area from the second area.

In one embodiment N₂ and H₂O are introduced into the first and the second area.

While the two areas of the ion source may be in a single vessel, there is a preferred embodiment, where the first area is a first ionization chamber and the second area is a second ionization chamber, first and second ionization chamber being connected to allow fluid exchange. The spatial separation of first and second area allows flow control of ions and/or neutrals from the first ionization chamber to the second ionization chamber more easily. Furthermore, the spatial separation allows for simple adjustment of the pressure in the second area without affecting the pressure in the first area. Hence, first area and second area are then first ionization chamber and second ionization chamber, respectively. The ionization source is preferably in the first area/ionization chamber. The source for the (electric) field is preferably in the second area/ionization chamber.

The invention further relates to a method for ionizing a sample with gaseous ammonium, comprising obtaining gaseous ammonium according to the method described above and ionizing the sample in a reaction chamber being connected with the exit of the second ionization chamber.

Furthermore the invention relates to a method of detecting the ion yield of the mass-to-charge ratio of ions produced by the method of the previous paragraph, by detecting the ions in an MS-instrument.

Finally, the inventions relates to an IMR-MS instrument, comprising
an ion source comprising a first area and a second area, an ionization source and at least one source for a electric field;
a reaction region connected to said ion source;
a mass spectrometer region connected to said reaction region;
at least one inlet for source gases;
at least one inlet for a sample into the reaction region;
an N₂-source;
a H₂O source;
at least one pump; and
a controlling device controlling
   flow of N₂ of the N₂-source,
   flow of H₂O of the H₂O-source.
   the least one pump,
   ionization source and
   the source for the electric field
so as to produce gaseous ammonium (NH₄⁺) in said second area and then conducting the NH₄⁺ to the reaction region.

Preferably, the first area and the second area are a first ionization chamber and a second ionization chamber, wherein said second ionization chamber is connected to said first ionization chamber, wherein the first ionization chamber includes the ionization source and the second ionization chamber includes the at least one source for the field.

It is preferred that the controlling device also controls the pressure in the second area.

Additionally, a source for a magnetic field may be present.

### DETAILED DESCRIPTION OF THE INVENTION

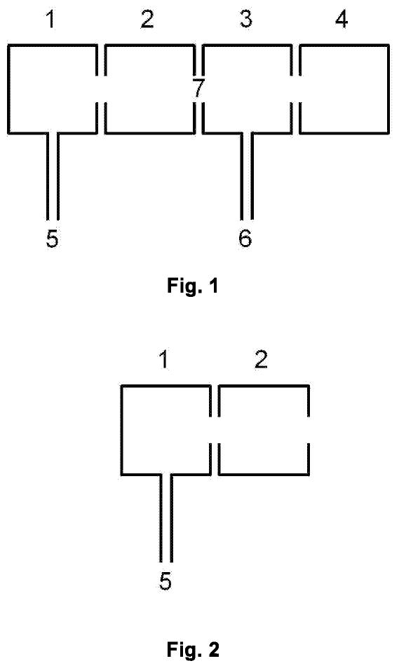

FIG. 1 is a schematic view of a typical IMR-MS instrument, comprising a first ionization chamber 1, a second ionization chamber 2, a reaction region 3 (e.g. drift, flow or flow-drift tube in PTR-, SIFT- and SIFDT-MS, respectively), a mass spectrometer region 4 (e.g. TOF, multipole, ion trap, MSⁿ, etc.), one or more inlet(s) 5 for source gases, one or more inlet(s) 6 for sample and, if needed, carrier or buffer gas, region 7 between 2 and 3.

FIG. 2 shows a schematic view of the parts needed for the present invention: first ionization chamber 1, second ionization chamber 2, one or more inlet(s) 5 for source gases.

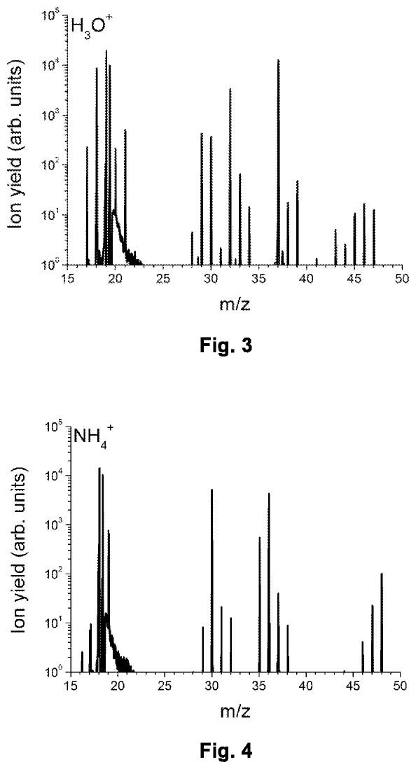

FIG. 3 shows a part of a mass spectrum obtained with the instrument running in H₃O⁺ mode.

FIG. 4 shows a part of a mass spectrum obtained with the instrument running in NH₄⁺ mode, i.e. in the mode according to the invention.

The present invention solves all of the above-mentioned problems associated with the use of NH₃ source gas and enables the generation of NH₄⁺ reagent ions at high purity levels without the introduction of NH₃, so that the NH₄⁺ can directly be used in IMR-MS instruments, which are not equipped with a filter for reagent ions, e.g. PTR-MS instruments. The invention can also be used in IMR-MS instruments, which are equipped with a filter for reagent ions, e.g. multipole mass filters in SIFT-MS or SIFDT-MS instruments. The invention does neither require any form of NH₃ nor any other toxic, harmful, environmentally hazardous or corrosive chemicals. The minimum required parts of an IMR-MS instrument necessary for the realization of the invention are schematically shown in FIG. 2.

NH₄⁺ reagent ions are generated by introducing N₂ and H₂O via a source gas inlet 5 into the first ionization chamber (FIC) 1 of an ion source, where N₂ and H₂O are ionized e.g. in a hollow cathode discharge, corona discharge, point discharge, plane electrode discharge, microwave discharge, radioactive ionization, electron ionization involving a filament, or via any other ionization method. The ionization products as well as (remaining) neutral N₂ and H₂O are introduced into a second ionization chamber (SIC) 2, which can either be spatially separated and connected via an aperture or form a part of the FIC 1. The pressure (and possibly also the electric fields) in the SIC 2 are adjusted so that via ion-molecule reactions the partly ionized species react to NH₄⁺ and only minor parasitic ions are left (e.g. below 10% and preferably below 5%). The pressure in the SIC 2 can e.g. be adjusted via a pump ring, which can be installed in or adjacent to the SIC 2 and connected to a pump via a valve or a pressure limiting aperture or via any other pressure adjusting mechanism applied to the SIC 2. The electric fields can be adjusted by adjusting the voltages and currents applied to different parts of the ion source.

In order to achieve NH₄⁺ in purity levels of higher than 90% and preferably higher than 95% (in relation to parasitic ions) primarily the ratio between the source gas flows into the FIC 1, i.e. N₂ and H₂O, and the pressure in the SIC 2 have to be optimized. The actual values depend strongly on the ion source used. The N₂:H₂O flow ratio typically is between 1:9 and 9:1, preferably between 3:7 and 7:3 and in some embodiments at about 1:1. The source of N₂ can be any N₂ source, preferably from an N₂ gas cylinder or an N₂ gas lab supply line. Using air as an N₂ source is also possible, as air largely consists of N₂. The purity of the generated NH₄⁺ is, however, negatively affected by the use of air, i.e. more parasitic ions are generated. This can be acceptable in case no pure N₂ is available or a reagent ion filtering device is used (e.g. in SIFT-MS, SIFDT-MS). The source of H₂O can be water vapor, preferably from the headspace of a water reservoir, which is evacuated by the suction created by the vacuum in the ion source. The flow rates of N₂ and H₂O can be controlled e.g. by mass flow controllers, valves, pressure limiting apertures, lines with suitable inner diameters, etc.

In one embodiment N₂ and H₂O are mixed prior to the source gas inlet 5 and introduced as a mixture. In another embodiment an additional source gas inlet is installed and N₂ and H₂O are introduced separately into the FIC 1. In another embodiment H₂O is introduced into the FIC 1 and N₂ is introduced via an additionally installed source gas inlet into the SIC 2, so that it expands into the FIC 1 and N₂ and H₂O are present in the FIC 1 and SIC 2. In another embodiment N₂ is introduced into the FIC 1 and H₂O is introduced via an additionally installed source gas inlet into the SIC 2, so that it expands into the FIC 1 and N₂ and H₂O are present in the FIC 1 and SIC 2. In another embodiment N₂ and H₂O are introduced via additionally installed source gas inlets into the SIC 2, so that the gases expand into the FIC 1 and N₂ and H₂O are present in the FIC 1 and SIC 2. Any other means of introducing N₂ and H₂O into the FIC 1 and SIC 2 are also possible. This includes, but is not limited to, backflow of N₂ and/or H₂O from any part of the instrument into FIC 1 and SIC 2, e.g. from the drift tube in case of a PTR-MS instrument.

The pressure in the SIC 2 should be at least at 0.01 hPa, should be below 100 hPa and has to be adjusted so that NH₄⁺ is efficiently generated. Further improvement of effective NH₄⁺ generation and suppression of parasitic ions can be achieved by applying electric fields, which accelerate ions in the FIC 1 and the SIC 2, respectively, from the FIC 1 into the SIC 2 and/or extract ions from the ion source.

Switching between NH₄⁺ generation and any other reagent ion can be done by switching the source gases, adjusting the source gas flows, adjusting the pressure in the SIC 2 and adjusting the electric fields. In particular, switching from NH₄⁺ to H₃O⁺ can be done by shutting off the N₂ flow, adjusting the H₂O flow, adjusting the pressure in the SIC 2 and adjusting the electric fields. Switching from H₃O⁺ (which is generated from H₂O) to NH₄⁺ can be done by adding N₂ to the ion source, adjusting the H₂O and N₂ flows, adjusting the pressure in the SIC 2 and adjusting the electric fields.

In the following example we applied the invention to a commercially available IMR-MS instrument, namely a PTR-TOF 1000 from IONICON Analytik GmbH., Austria. The example should by no means limit the applicability of the invention to a specific instrument or specific settings. For this particular instrument the FIC 1 is a hollow cathode ion source, the SIC 2 is a source drift region, the reaction region 3 is a drift tube consisting of a series of electrically isolated stainless steel rings with an applied voltage gradient and the mass spectrometer region 4 is a TOF mass spectrometer.

The source gas inlet 5 is connected to two source gas lines, with a mass flow controller installed in each line. The headspace above purified water and N₂ from a gas cylinder (99.999% purity) is connected to the lines, respectively. Sample inlet 6 is fed with purified air. At the intermediate position 7 between the SIC 2 and the reaction region 3 a pump ring is installed, which is connected to a split-flow turbo-molecular pump via an electronically controllable proportional valve. Thus the pressure in the SIC 2 can be adjusted by adjusting this so-called source valve, where 0% means the valve is fully closed, i.e. no pumping power is applied, and 100% means the valve is fully opened, i.e. maximum pumping power is applied. As this is a PTR-MS instrument, no filtering device is installed between the ion source and the reaction region and therefore, if purified air is introduced to the sample inlet, i.e. negligible impurities are introduced into the reaction region, the purity of the reagent ions can be directly measured with the mass spectrometer 4. For the measurements a drift tube pressure of 2.3 hPa and a drift tube temperature of 60° C. were selected. The hollow cathode ion source 1 was operated at a discharge current of 3.5 mA.

FIG. 3 shows a part of the mass spectrum with a mass-to-charge ratio m/z between 15 and 50, i.e. the region where impurities from the ion source are expected. The ion source is operated with the established H₃O⁺ reagent ions. The H₂O source gas is set to 6.5 sccm (cm³ per min at standard conditions), no N₂ source gas is added. The source valve is set to 54%. The voltage, which is applied to extract ions from the FIC 1 to the source drift region 2 is set to 130 V. It has to be noted that the detector gets overloaded by the high ion yield at m/z 19, which corresponds to H₃O⁺. Therefore, the ion yield at m/z 21, which corresponds to a naturally occurring isotope of H₃O⁺ has to be multiplied by a factor of 500 in order to get the number of reagent ions. With these ion source settings and a drift tube voltage of 600 V applied, a H₃O⁺ reagent ion yield of about 22×10⁶ cps (ion counts per second) is achieved. The relative amount of parasitic ions are about 4.6% plus about 2.4% water cluster 2(H₂O).H⁺ at m/z 37, which is dependent on the drift tube voltage.

FIG. 4 shows a part of the mass spectrum with a mass-to-charge ratio m/z between 15 and 50 after the invention has been applied. The switching time takes about 3-5 s and is mainly limited by the response time of the mass flow controllers controlling the source gas flows. The H₂O flow is set to 3 sccm and the N₂ flow is set to 3 sccm, i.e. the ratio between H₂O and N₂ is 1:1. The source valve is set to 45%, i.e. lower than for H₃O⁺ generation, which means that the pressure in the source drift region 2 is increased. The voltage, which is applied to extract ions from the FIC 1 to the source drift region 2 is set to 250 V, i.e. higher than for H₃O⁺ generation. It has to be noted that the detector gets overloaded by the high ion yield at m/z 18, which corresponds to NH₄⁺. Therefore the ion yield at m/z 19, which corresponds to a naturally occurring isotope of NH₄⁺ and can be separated from the parasitic H₃O⁺ sharing the same nominal m/z, because of the high mass resolution of the utilized TOF mass spectrometer 4, has to be multiplied by a factor of 250 in order to get the number of NH₄⁺ reagent ions.

With these ion source settings and a drift tube 3 voltage of 650 V applied, a NH₄⁺ reagent ion yield of about 19×10⁶ cps, i.e. a comparable intensity to the H₃O⁺ mode, is achieved. The relative amounts of parasitic ions are about 2.4%, i.e. the reagent ions are even more pure than in H₃O⁺ mode, plus about 0.1% 2(NH₃).H⁺ at m/z 35, which is dependent on the drift tube voltage.

With this particular instrumental setup we could achieve NH₄⁺ ion yields with high purity and high abundance at pressures in the source drift region 2 between about 2-4 hPa and electric field strengths in the source drift region 2 of 350-800 V/cm². These pressure and field strength regions will vary considerably depending on the geometry and the type of the ion source.

Switching back to H₃O⁺ by applying the above-mentioned settings for H₃O⁺ mode again just takes seconds and the relative amount of remaining parasitic NH₄⁺ drops below 10% nearly instantaneously and below 4% after some tens of seconds.

In cases where extremely high purity of NH₄⁺ is needed and even minor amounts of parasitic H₃O⁺ and 2(H₂O).H⁺ ions need to be avoided, a compound with a PA, which is higher than the PA of 2(H₂O) (808 kJ/mol; thus also higher than the PA of H₂O), but lower than the PA of NH₃ (i.e. PA between 808 and 854 kJ/mol) can be added in sufficient concentration to the reaction region 3, e.g. via the sample inlet 6. This will cause the parasitic H₃O⁺ and 2(H₂O).H⁺ to react with this compound, leading to depletion of the parasitic water and water cluster ions.

In summary the invention enables the powerful capability of operating an IMR-MS instrument with NH₄⁺ reagent ions. No NH₃ or any other harmful, toxic, environmentally hazardous, corrosive, etc. compounds are necessary for NH₄⁺ production. The only compounds needed are N₂ and H₂O. These compounds are injected into the ionization region of a FIC 1 and subsequently left in a SIC 2 until the partially ionized products predominantly react to NH₄⁺. In our example we used a PTR-MS ion source, originally designed for being operated with H₃O₃O reagent ions, introduced N₂ and H₂O with a ratio of 1:1 into the ionization region 1 and increased the pressure in the source drift region 2 (compared to the pressure used for H₃O⁺ generation) in order to get NH₄⁺ reagent ions with a purity of more than 97%. Additionally, we increased the voltage extracting ions from the FIC 1 into the SIC 2 compared to the voltage used for H₃O⁺ generation. Switching between reagent ions could be achieved within seconds. The invention is by no means limited to this example, but works with any IMR-MS ion source.

1. A method for ionizing a sample with gaseous ammonium, comprising:
(i) obtaining gaseous ammonium (NH₄⁺) from an ion source, the ion source comprising a first area and a second area in a fluidly conductive connection, comprising the steps of:
(a1) introducing a controlled flow of N₂ into the first area or second area of the ion source;
(a2) introducing a controlled flow of H₂O₂O into the first area or second area of the ion source;
(b) applying an ionization method to the mixture of N₂ and H₂O in the first area;
(c) applying at least one electric field or adjusting pressure conditions or a combination of applying at least one electric field and adjusting pressure conditions promoting flow of ions from the first area to the second area and inducing reactions of the ions in the second area (2);
(d) conducting NH₄⁺ out of the ion source; and
(ii) ionizing the sample in a reaction chamber being connected with the ion source.

2. The method according to claim 1, wherein the first area is a first ionization chamber and the second area is a second ionization chamber being connected to allow fluid exchange.

3. The method according to claim 2, wherein the ionization source for applying the ionization method is in the first ionization chamber and/or the source for the electric field is in the second ionization chamber.

4. The method according to claim 1, further comprising applying amagnetic field.

5. The method according to claim 1, wherein the mixing ratio of N₂ to H₂O in the first ionization chamber is between 1:9 and 9:1.

6. The method according to claim 1, wherein the N₂ source is essentially pure gaseous N₂.

7. The method according to claim 1, wherein N₂ and H₂O are mixed prior to the introduction into the ion source.

8. The method according to claim 1, wherein N₂ and H₂O are introduced into the ion source separately and are mixed directly in the ion source.

9. The method according to claim 1, wherein N₂ and/or H₂O are introduced in the second area and N₂ and/or H₂O flow into the first area from the second ionization chamber.

10. (canceled)

11. A method of detecting the ion yield of the mass-to-charge ratio of ions produced according to claim 1, by detecting the ions in Mass Spectrometry instrument.

12. An Ion-Molecule-Reaction-Mass Spectrometry (IMR-MS) instrument, comprising
an ion source with a first area and a second area, an ionization source and at least one source for an electric field;
a reaction region connected to said ion source;
a mass spectrometer region connected to said reaction region;
at least one inlet for source gases;
at least one inlet for a sample into the reaction region;
an N₂-source;
a H₂O source;
at least one pump; further comprising:
a controlling device controlling
flow of N₂ of the N₂-source,
flow of H₂O of the H₂O-source.
the least one pump,
ionization source, and
the source for the electric field,
so as to produce gaseous ammonium (NH₄⁺) in said second area and then conducting NH₄⁺ to the reaction region via an exit.

13. The IMR-MS instrument according to claim 12, wherein the controlling device also controls the pressure in the second area.

14. The IMR-MS instrument according to claim 12, wherein the first area and the second area are a first ionization chamber and a second ionization chamber, wherein said second ionization chamber is connected to said first ionization chamber, wherein the first ionization chamber includes the ionization source and the second ionization chamber includes the at least one source for the electric field.

15. The IMR-MS instrument according to claim 12, further comprising an additional source for a magnetic field.

16. The method according to claim 5, wherein the mixing ratio of N₂ to H₂O in the first ionization chamber is between 3:7 and 7:3.

17. The method according to claim 5, wherein the mixing ratio of N₂ to H₂O in the first ionization chamber is approximately 1:1.
